(19) United States
(12) Patent Application Publication
(10) Pub. No.: US 2004/0201583 A1
(43) Pub. Date: Oct. 14, 2004

(54) Methods for controlling a light-emissive display

(75) Inventors: Jeremy Burroughes, Cambridge (GB); Richard H. Friend, Cambridge (GB); Karl Pichler, Wappingers Falls, NY (US)

Correspondence Address: MARSHALL, GERSTEIN & BORUN LLP, 6300 SEARS TOWER, 233 S. WACKER DRIVE, CHICAGO, IL, 60606, US

(73) Assignee: Cambridge Display Technology Limited

(21) Appl. No.: 10/834,972

(22) Filed: Apr. 29, 2004

Related U.S. Application Data
(63) Continuation of application No. 09/687,682, filed on Oct. 13, 2000.
Application No. 09/687,682 is a continuation of application No. PCT/GB99/01145, filed on Apr. 14, 1999.

(30) Foreign Application Priority Data
Apr. 15, 1998 (GB) 9808016.1
May 13, 1998 (GB) 9810280.9

(51) Int. Cl. G09G 5/00

(52) U.S. Cl. 345/211

(57) ABSTRACT

A display control device for a light-emissive display comprising: input means for receiving display data defining a visual display pattern, processing means for processing the display data to generate control data for controlling the pixels of the display and having a first, normal mode of operation in which it controls the pixels to display the pattern as defined by the display data, and a second, power-saving mode of operation in which it controls a set of pixels of the display to operate with reduced power consumption whilst maintaining display of the pattern, and output means for connection to the pixels to transmit the control data to the pixels.

This invention relates to display controllers and methods for controlling light-emissive displays, particularly with the aim of reducing power consumption.

Display devices for general applications typically have a matrix of pixels arranged orthogonally in rows and columns. The pixels are individually controllable by a display controller device which is connected to the display so as to be able to address and control the state of each pixel individually. In many applications there is a need to reduce a display's power consumption. This is especially so in applications such as portable computers where the display is battery-powered and is formed with light-emissive pixels provided by devices such as LEDs, field emission devices or organic or inorganic electroluminescent devices.

Most efforts in improving the efficiency of display devices have been directed to structural aspects of the devices, for example to improve external quantum efficiency. However, these developments tend to have relatively small incremental effects on device efficiency.

One aim of this invention is to allow the efficiency of display devices to be enhanced by improvements to the methods and/or means of controlling the devices.

According to a first aspect of the present invention there is provided a display control device for a light-emissive display, comprising: input means for receiving display data defining a visual display pattern; processing means for processing the display data to generate control data for controlling the pixels of the display and having a first, normal mode of operation in which it controls the pixels to display the pattern as defined by the display data, and a second, power-saving mode of operation in which it controls a set of pixels of the display to operate with reduced power consumption whilst maintaining display of the pattern; and output means for connection to the pixels to transmit the control data to the pixels.

According to a second aspect of the present invention there is provided a display control device for a light-emissive display, comprising: input means for receiving display data defining a visual display pattern; processing means for processing the display data to generate control data for controlling the pixels of the display and having a first, normal mode of operation in which it controls the pixels to display the pattern as defined by the display data, and a second, power-saving mode of operation in which it controls a set of pixels of a part of the area of the display to operate with reduced power consumption, and output means for connection to the pixels to transmit the control data to the pixels.

The set of pixels may comprise all or only some of the pixels of the display. When the set of pixels comprises only some of the pixels of the display they are preferably adjacent pixels. The set of pixels preferably represents a user interface area of the display (e.g. a menu or icon) or an area of the display that is occupied by text.

In the power-saving mode of operation the pixels of the set are suitably controlled so as to invert their brightnesses in comparison to the, normal mode of operation. (suitably whilst maintaining the relative contrast of the pixels of the set) or to reduce their brightnesses of the pixels in comparison to the normal mode of operation (suitably whilst reducing the relative contrast of the pixels of the set).

The display control device may itself determine when to enter or leave the power-saving mode, or it may receive instructions to do so from another device. The display control device may comprise monitoring means for monitoring (directly or indirectly) the operation of user input means (e.g. a mouse or keyboard) of an associated device (suitably the device that generates the display data). The display control device may also include timing means for timing the duration since the last operation of the user input means and causing the processing means to enter the power saving mode of operation when longer than a predetermined duration has elapsed. The monitoring means may be capable of causing the processing means to enter the normal mode of operation in response to operation of the user input means. Where the set of pixels represent a localised region of the display (e.g. a user interface region) the monitoring means may cause the processing means to enter the normal mode of operation in response to movement by the user interface means of a pointer (e.g. a mouse pointer or a cursor) to or near to that localised region.

In the power-saving mode of operation the pixels other than those of the said set are preferably controlled as in the normal mode of operation. Alternatively, two or more sets of pixels of the display-may be controlled in similar or different power-saving schemes.

The pattern is preferably a pattern of differentiated pixel brightness. When the pattern is maintained relative differences in brightness are preferably maintained.

According to a third aspect of the invention there is provided a display control device as described above and a display. The display preferably comprises a plurality of pixels. The pixels may be disposed in an orthogonal grid layout, or in other regular layouts, or irregularly disposed.

The display, is preferably a light-emissive display, preferably an organic light-emissive display. The pixels preferably comprise light-emissive regions which suitably comprise an organic light-emissive material for light emission and/or thin-film transistor control circuitry. One preferred structure for a pixel is that it comprises a layer of organic light-emissive material between two charge-carrier injecting layers—suitably anode and cathode electrodes. Some preferred materials for such a pixel are as follows:

One of the charge carrier injecting layers (the hole injecting layer) preferably has a work function of greater than 4.3 eV. That layer may comprise a metallic oxide such as indium-tin oxide (“ITO”) or tin oxide (“TO”). The other charge carrier injecting layer (the electron injecting layer) preferably has a work function less than 3.5 eV. That layer may suitably be made of a metal with a low work function (Ca, Ba, Yb, Sm, Li etc.) or an alloy comprising one or more of such metals together optionally with other metals (e.g. Al). At least one of the electrode layers is suitably light transmissive, and preferably transparent, suitably at the frequency of light emission from the pixel.

There may be one or more charge transport layers between the light-emissive material and the charge carrier injecting layers. The transport layer may suitably comprise one or more polymers such as polystyrene sulphonic acid doped polyethylene dioxythiophene (“PEDOT-PSS”) and/or poly(2,7-(9,9-di-n-octylfluorene)-(1,4-phenylene-(4-imino(benzoic acid))-1,4-phenylene-(4-imino(benzoic acid))-1,4-phenylene)) (“BFA”) and/or polyaniline and/or PPV.

The light-emissive layer may comprise one or more organic materials, suitably polymers, preferably conjugated or partially conjugated polymers. Suitable materials include poly(p-phenylenevinylene) (“PPV”), poly(2-methoxy-5(2′-ethyl)hexyloxyphenylene-vinylene) (“MEH-PPV”), a PPV-derivative (e.g. a di-alkoxy or di-alkyl derivative), a polyfluorene and/or a co-polymer incorporating polyfluorene segments, PPVs and/or related co-polymers, poly (2,7-(9,9-di-n-octylfluorene)-(1,4-phenylene-((4-secbutylphenyl)imino)-1,4-phenylene)) (“TFB”), poly(2,7-(9,9-di-n-octylfluorene)-(1,4-phenylene-((4-methylphenyl)imino)-1,4-phenylene-((4-methylphenyl)imino)-1,4-phenylene)) (“PFM”), poly(2,7-(9,9-di-n-octylfluorene)-(1,4-phenylene-((4-methoxyphenyl)imino)-1,4-phenylene-((4-methoxyphenyl)imino)-1,4-phenylene)) (“PFMO”), F8 or F8BT. Alternative materials include organic molecular light-emissive materials, e.g. Alq₃, or any other small sublimed molecule or conjugated polymer electroluminescent material as known in the prior art.

The processing means is suitably responsive to a photodetector to enter the power-saving mode, or to reduce the brightness of all or part of the display, when the photo-detector detects a brightness lower than a predetermined threshold. The processing means may perform other processing in dependence on the output of the photo-detector. The threshold may represent one step in a more complex power saving routine performed in dependence on the output of the photo-detector: for example, the power of the display could be reduced gradually as the detected light decreases. The photo-detector is preferably arranged to detect a representation of the light incident on the display. One step in achieving this is preferably for the detector to be optically isolated from the light emitted from the display. The processing means may be responsive to one or more such photo-detectors. Most preferably the or each photo-detector is located in the display, for instance as a pixel of the display, but other solutions are possible, as described below. Regions of the display may be controlled independently in dependence on one or more photo-detectors.

The display and/or the display controller are suitably battery-powered and/or adapted for being battery-powered.

The present invention will now be described by way of example with reference to the accompanying drawings, in which:

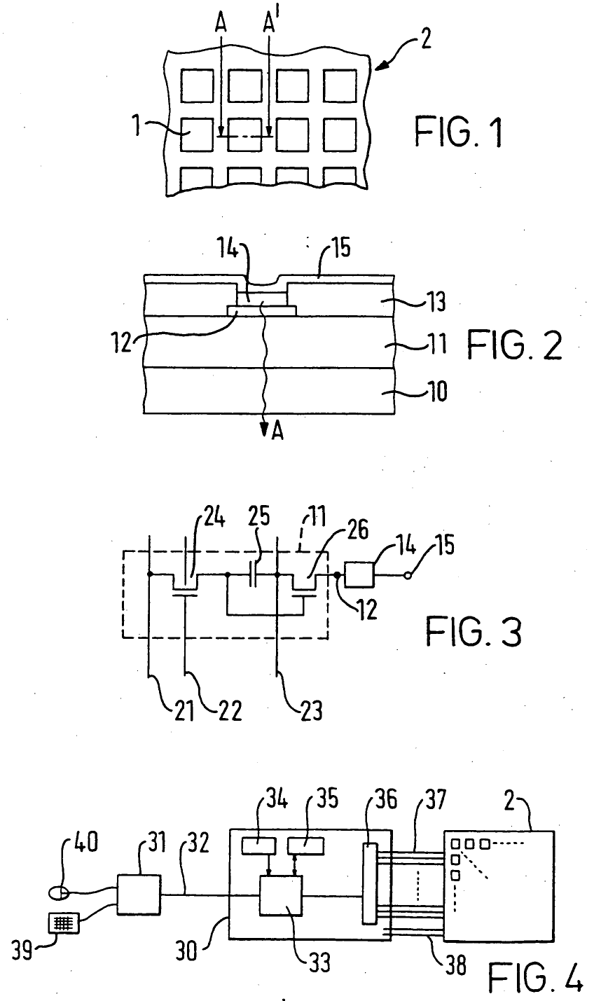

FIG. 1 shows a plan view of some of the pixels of an organic light-emissive display device;

FIG. 2 shows a cross-section of the device on the line A-A′ in FIG. 1 to illustrate the structure of one of the pixels;

FIG. 3 shows a circuit diagram of the pixel of FIG. 2;

FIG. 4 shows a schematic diagram of a multi-pixel device and its control apparatus; and

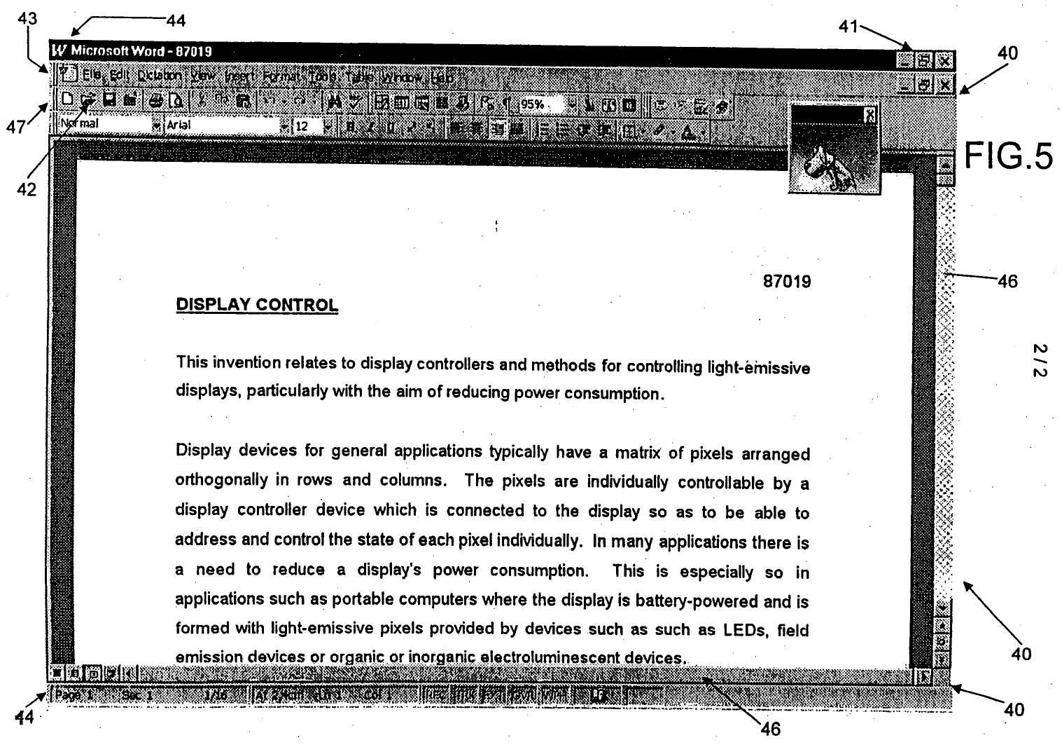

FIG. 5 shows a typical computer screen display.

FIG. 1 shows some of the pixels of an organic light-emitting display device. The pixels are arranged in orthogonal rows and columns. Typical sizes for the entire display range from 100×100 pixels to 1000×1000, but larger or smaller sizes, and sizes with unequal numbers of pixels on each side are possible.

FIG. 2 shows a cross section of pixel unit 1 in FIG. 1. The display is formed on a light-transmissive substrate 10, such as a glass sheet. On the glass sheet is deposited conventional thin-film transistor (TFT) circuitry (shown generally at 11) to define an active matrix display control circuit. The active matrix circuitry will be described in more detail below. The active matrix circuitry terminates in an anode electrode 12. The anode electrode is of a light-transmissive conductive material such as indium-tin oxide (ITO). A bank layer 13 of an insulating material such as SiO₂ is deposited over the TFT circuitry and is patterned as shown, to leave holes through the bank layer over the anode electrodes. Then an organic light-emissive material 14 is deposited. The organic material could be deposited as a layer over the whole device (e.g. by spin-coating a precursor polymer) and then patterned to form individual pixels or areas of pixels; or the pixels/areas could be deposited individually (e.g. by ink-jet printing), especially when forming a multi-colour (e.g. red/green/blue) device with pixels which each emit different colours of light. The resulting layer of organic material is around 1000 Å A thick. To deposit the light-emitting material by ink-jet printing the material may be sprayed through an ink-jet printer spray head. A suitable spraying cycle is 14,400 drops per second, with a drop volume of 30 pl. Finally, a cathode electrode 15, for example of a aluminium:lithium alloy, is deposited over the whole device.

Numerous materials could be used for the layer 14, for example conjugated polymers such as poly(p-phenylenevinylene) (“PPV”) or poly(2-methoxy-5(2′-thyl) hexyloxyphenylene-vinylene) (“MEH-PPV”) or small-molecule materials such as tris(8-hydroxyquinoline)aluminium (Alq₃). Details of such materials can be found in, for example, PCT/WO90/13148 and U.S. Pat. No. 4,539,507 the contents of both of which are incorporated herein by reference.

FIG. 3 shows a circuit diagram for the TFT circuitry associated with the pixel unit 1. The light-emissive region itself is illustrated as block 14, which is connected between electrodes 12 and 15. The TFT circuitry receives inputs from three lines: row electrode 20, column electrode 21 and current supply electrode 22. Current supply electrode 22 is connected to the TFT circuits of all the pixels of the display device and a voltage sufficient for emission from the pixels of the display is applied constantly between it and electrode 15. Each pixel can be addressed individually by its row and column electrodes because any pair of row and column electrodes intersect at a single pixel. When voltages are applied to row and column electrodes 20,21 the switching transistor 24 is turned on and the storage capacitor 25 is charged. Electrodes 20 and 21 can then be turned off and another pixel addressed. Since the capacitor 25 is charged the current transistor 26 is switched on and the voltage applied at electrode 23 is applied to the pixel, causing it to emit. The brightness of the pixel can be controlled by controlling the charging of capacitor 25 (and therefore the turn-on state of transistor 26) by means of electrodes 21 and 22.

FIG. 4 shows an arrangement for controlling the display device 2. The display device is connected to a display controller 30, which acts .as an interface between the display device and a source of video data such as a computer 31. (The display controller could be integrated with the display). The computer 31 supplies video data to the display controller by means of line 32. The video data defines the visual pattern to be shown on the display. The display controller comprises a processor 33 which receives the video data, a memory 34 which stores instructions for the processor, a memory 35 which is used by the processor as a temporary store and a multiplexer 36 which is connected at 37 to the row and column electrodes of the display 2. At 38 the display controller also supplies a constant voltage between the electrodes 23 and 15.

Video data from the computer 31 is stored by the processor 33 (on the basis of the instructions stored in memory 34) in a video memory space in memory 35 as information defining the status of each pixel of the display according to the video data. In a simple device the status may be just “on” or “off”, but in a more complex device brightness information may need to be stored and the processor may need to convert colour information in the video feed at 32 into information for individual single-colour (e.g. red, green or blue) pixels. On the basis of the instructions in memory 34 and the interpreted video data in memory 35 the processor also outputs information to the multiplexer 36 to refresh the display.

The computer 31 can also send instructions to the processor 30, for example to change its mode of operation. The processor can store information on its mode of operation in the memory 35. Especially where the display controller is integrated with the computer 31 (or with an alternative source of video information) the processor 30 is suitably able to monitor the status of the computer (or other source), especially to check for events such as key-presses or movements of a mouse.

In a normal mode of operation the display controller controls the pixels just as defined by the video data. Unlike typical liquid crystal displays (LCDs) the power used by each pixel of this device is not independent of the pixel's brightness. By exploiting this feature the display controller implements several functions that can be used to reduce power consumption by the display.

First, the display controller is capable of inverting the brightnesses of all the pixels of the display: changing dim pixels to be bright, off pixels to be on, etc. This can be done (e.g.) under command of the computer 31 or in response to an event such as the operation of a user input device of the computer 31 or in response to a predetermined time elapsing from a certain event or in response to the status of the display itself. Each pixel of the display 2 uses more power the brighter it is. Therefore, when most of the screen is bright, inverting the brightness of the display will save power. One example is when the display is displaying text: because the characters of text typically occupy relatively little of the display compared to the background a significant amount of power (possibly 90%) can be saved by using a format with bright text on a dark background rather than dark text on a bright background. However, users may prefer the latter configuration. To accommodate this the system may provide for the following types of operation, which are merely examples. The display may be inverted so as to save power (suitably to implement a relatively low background brightness) when (e.g.):

1. Instructed directly do so.

2. A predetermined (e.g. user-set) time elapses from the operation of user input devices of the computer (e.g. a keyboard 39 and/or mouse 40).

3. The display controller detects by monitoring the display status (either from the contents of memory 35 or from the power supplied at 38) that it would save power if the display brightness were inverted. A minimum time delay may be specified between one inversion and the next, so as to reduce flickering of the display.

4. Text is being displayed over a predetermined (e.g. user-set) area of the display.

5. Remaining battery power is below a predetermined (e.g. user-set level).

The display may be inverted so as to leave a power saving state when (e.g.):

1. Instructed directly to do so.

2. One of the user input devices of the computer is operated.

3. Text is being displayed over less than a predetermined (e.g. user-set) area of the display.

The user may configure the system to select which of the circumstances are to cause inversion of the display. The selected circumstances may correspond to a mode of the display controller 30 which can be selected via computer 31. The circumstances may apply in combination—for instance to specify switching to the power saving mode when text is being displayed over a predetermined (e.g. user-set) area of the display and a predetermined time elapses from the operation of user input devices of the computer.

By using a low-power “white-on-black” mode, an organic electroluminescent display of the type described above may (in text-display applications) be projected to operate at a time-averaged current density as low as 0.1 mAcm² at a drive voltage of less than 10 V, giving a power consumption of less than 1 mW/cm².

FIG. 5 shows a typical computer display in a Microsoft™ windows environment. As in other environments (especially graphical user interface environments) the display includes areas (indicated generally at 40 in FIG. 5) which represent user interface features such as menus; buttons for controlling windows 41, controlling program features 42 or activating programs; and standard graphical window features such as menu bars 43, status indicators 44, title bars 45, sliders 46 and toolbars 47. These user interface features are commonly displayed in a constant position on the screen, and for much of the time when a computer display is in operation they are not needed by a user.

A second power-saving function of the present system is to invert the brightness of, dim (e.g. uniformly reduce the brightness of) or turn off areas of the display that are occupied by such user interface features. Again, such a power saving state can be triggered by one or more of a number of events either alone or in combination—when:

1. There is a direct instruction to do so.

2. A predetermined (e.g. user-set) time elapses from the operation of user input devices of the computer (e.g. a keyboard and/or mouse).

3. A predetermined (e.g. user-set) time elapses from the use of the user interface feature in question.

4. The display controller detects by monitoring the display status (from memory 35) that it would save power if the power saving state were used for one or more of the user interface features. A minimum time delay may be specified between one change and the next, so as to reduce flickering.

5. Remaining battery power is below a predetermined (e.g. user-set level).

The display of the user interface features may be reverted to its natural state when:

1. There is a direct instruction to do so.

2. One of the user input devices of the computer is operated.

3. The appearance of the -user interface feature changes.

4. A pointer (e.g. a mouse pointer) is moved on or near to the feature.

5. Remaining battery power is above a predetermined (e.g. user-set) level, or another power source is available.

Again, the user may configure the system to select which of these circumstances are to cause inversion of the display. The selected circumstances may correspond to a mode of the display controller 30. The circumstances may apply in combination.

Another advantage of this second power-saving aspect is that it can address the problem that since many user interface features remain in one place on the display for a prolonged time they can accelerate deterioration of the display over heavily used parts of the display (“windows burn-in”). This may be addressed by, for at least part of the time, reducing the intensity of the features or not displaying them at all.

The brightness of all the user interface features on the display may be adjusted together or independently.

The user interface features may be detected by a pattern-matching routine executed by the processor 33 or by means of direct information sent by the computer 31 to the display controller to inform the display controller specifically of the location of the user interface features.

When the intensity of the user interface features is reduced text and/or other information could be moved over the keyboard in order to time average the integrated light output over the whole screen.

When bright light is incident on the display the amount of reflected light is high and the display's contrast is reduced, and it is difficult for a user to view the displayed image. This effect can be countered by increasing the brightness of the display, but that :increases the display's power consumption and may reduce its expected lifetime. A solution to this problem is to use the level of ambient light as another parameter in determining how the display is to operate. One approach is to install a photo-detector beside the display to measure the incident light; the display controller is then arranged to receive the output of the photo-detector and to be responsive to the photo-detector to increase the brightness of the display as the intensity of incident light detected by the photo-detector increases.

A photo-detector beside the display could be a component independent from the display (e.g. fitted to the display surround or packaging) or could be integrated with the display. To integrate the detector with the display it could be deposited on the same substrate as the display and/or share one or more of the other components of the display (e.g. one or more layers of material which make up the display pixels). Such a detector could be an organic, inorganic or hybrid detector, and could have the same structure as the display or a different structure. The detector should ideally be arranged so that the light it detects is directly or indirectly representative of the light incident on the display itself.

The detector should be optically isolated from the display so that it does not detect light emitted from the display itself. This could be achieved by an opaque barrier between the detector and the display, or by the detector measuring the ambient light when the display is not emitting, for instance during the display's refresh cycle.

A more sophisticated solution is to provide a plurality of photo-detectors around the periphery of the display; for example to provide four detectors, one located at each corner of the display. Then the display controller could control the brightness of the display in dependence on the brightnesses detected by all the detectors. One possibility is for the brightness of the whole display to be adjusted in dependence on a function (e.g. an average or maximum) of the brightnesses detected by all the detectors. Another possibility is for the brightness of regions of the display to be adjusted independently, e.g. in dependence on the brightness detected by the detector nearest to that region. In the latter case it would be advantageous to control the brightness at the boundaries between the regions to smooth out differences in display brightness. These solutions could be especially valuable for larger displays (e.g. greater than 10 cm×10 cm) where the incident light on the display may be significantly non-uniform over the display's area.

A still more advanced solution is to integrate one or more photo-detectors into the display itself. One approach is to use a pixel of the display as a photo-detector. The pixel is stopped from emitting and reverse-biased so that it acts as a photo-detector. The resulting signal is sent to the display controller, possibly via other equipment such as an amplifier, for use as described above. The measurement step is preferably brief, so that light emission by the pixel is not interrupted obtrusively. The measurement step could be performed during the display's refresh cycle, or emission from the entire display or from the pixel(s) that is/are to be used for detection could be stopped temporarily to allow measurement. One or more of the display's pixels could be used in this way, for example a grid of spaced-apart pixels could be used for detection. In large displays this approach is especially valuable because it allows for measurement of incident light at locations far from the periphery of the display.

The step of detecting the ambient light may be performed relatively infrequently (e.g. once every 5 or 10 seconds or longer) because the level of ambient light will rarely change greatly over a short period. Alternatively, the ambient light may be detected more frequently.

Detection of ambient light above a pre-set threshold may be another event that can trigger (either by itself or in conjunction with another event) one of the power-saving modes described above.

The principles set out above could be combined to provide for a gradual power reduction during inactivity or partial inactivity of a user. For example, after a first time-period the second power saving feature could be implemented to reduce the intensity of one or more user interface features and after a second (longer) time period the first power saving feature could be implemented to invert the brightness of a text area or of all of the display. Finally, after a third still longer period the display could be turned off.

The principles set out above can be applied to other types of display. For example a passive matrix display (where each pixel is connected between its row and column lines and is driven directly by them with no storage circuitry) could be used. The organic light-emissive pixels could be replaced by inorganic light-emissive pixels. Alternative devices for the pixels include field emission devices, inorganic electroluminescent devices and, generally, LED devices. The pixels could be used as backlights for one or more LCD pixels of an overlain LCD display plane. The pixels could be of different shapes (for example of special part-character shapes) or laid out in different array configurations (non-orthogonal, for example); one specific example is alpha-numeric character displays. The display could be monochrome or colour (for instance with pixels in groups of red, green and blue).

The unit described as computer 31 above could, for example, be a portable or desk-top personal computer, a portable digital assistant (“PDA”) or a mobile phone.

The operations of user input devices referred to above could be any suitable operation for example movement of a mouse or pressing of any key on a keyboard—or a predefined (e.g. user-set) operation or sequence of operations—for example pressing a combination of keys at the same time. Other user input devices such as trackballs, touchpads etc. could be used.

The direct instructions mentioned above could be from a user (by means of a menu command, a typed command or a mechanical switch) or from the device 31 to the display controller 30.

The present invention may include any feature or combination of features disclosed herein either implicitly or explicitly or any generalisation thereof irrespective of whether it relates to the presently claimed invention. In view of the foregoing description it will be evident to a person skilled in the art that various modifications may be made within the scope of the invention.

What is claimed is:

1. A method for controlling a light-emissive display, comprising:
displaying a pattern on a light-emissive display including a plurality of pixels;
detecting a light incident on the light-emissive display with at least one of the plurality of pixels and generating intensity information therefrom; and,
adjusting the brightness of a group of the plurality of pixels based on the intensity information while maintaining the displaying of the pattern.

2. The method of claim 1, wherein the pixels are light-emitting diodes having a light-emitting state and a non-emitting state.

3. The method of claim 2, wherein the detecting is performed by a light-emitting diode in the non-emitting state.

4. The method of claim 1, wherein the adjusting comprises inverting the brightness of the plurality of pixels.

5. The method of claim 1, wherein the adjusting comprises reducing the brightness of the group when the intensity of the light incident on the light-emissive display decreases.

6. The method of claim 5, wherein the brightness of the light-emissive display is reduced when the intensity information is lower than a predetermined threshold.

7. The method of claim 1, wherein the adjusting comprises increasing the brightness of the group when the intensity of the light incident on the light-emissive display increases.

8. The method of claim 1, wherein the brightness of the light-emissive display is increased when the intensity information is greater than a predetermined threshold.

9. The method of claim 1, wherein the detecting is performed without interrupting the displaying of the pattern.
